(19) United States
(12) Patent Application Publication
(10) Pub. No.: US 2005/0223853 A1
(43) Pub. Date: Oct. 13, 2005

(54) Tool with colored patterns

(76) Inventor: Li-Tu Lin Wu, Taichung (TW)

Correspondence Address: TROXELL LAW OFFICE PLLC, Suite 1404, 5205 Leesburg Pike, Falls Church, VA, 22041, US

(21) Appl. No.: 10/820,867

(22) Filed: Apr. 9, 2004

(51) Int. Cl. B25B 13/02

(52) U.S. Cl. 81/119

(57) ABSTRACT

A tool with colored patterns has a tool body having a surface and at least one colored pattern layer. The at least one colored pattern layer may form exquisite and colorful characters or figures and may be attached to any the surface of the tool. Therefore the appearance of the tool is more attractive, and a user can see the characters or figures on the tool and identify the tool easily.

### BACKGROUND OF THE INVENTION

1. Field of the Invention

The present invention relates to a tool, and more particularly to a tool with an exterior surface having colored patterns bonded to the surface without regard to the shape of the surface.

2. Description of Related Art

A conventional tool such as a wrench used to turn a bolt has a tool body usually made of metal. The tool body usually has a surface on which characters, logos, decorations or marks to identify the owner are applied. The characters, etc. are applied to the surface of the tool body by punching, printing or etching. Conventional techniques of applying the characters, etc. mandate that the characters, etc. be applied to flat surfaces instead of curved surfaces. However, tool bodies' has irregular shapes so surfaces of tool bodies are flat and curved so characters and figures are difficult to form on the tool body, especially when the characters and figures are intricate and need precision punching or printing. Therefore, the characters and figures are often restricted to flat surfaces of the tool body. Furthermore, colors of the characters and figures made by punching or printing are poorly defined. Therefore the characters and figures on the tool look rough and drab so the appearance of the tool is not attractive. Furthermore, the punching or printing characters and figures on the tool body is expensive and increases the cost of the tool.

To overcome the shortcomings, the present invention provides an automobile curtain device to mitigate or obviate the aforementioned problems.

### SUMMARY OF THE INVENTION

One objective of the invention is to provide a tool with colored patterns such that characters and figures composed of a colored pattern layer of a tool body are more colorful and distinct and make the tool look more attractive and aesthetic.

Another objective of the invention is to provide an economical means of forming colored patterns on the tool body to reduce the cost of the tool.

A tool with colored patterns in accordance with the present invention comprises a tool body, at least one colored pattern layer and at least one optional composite layer.

The least one colored pattern layer is applied to a surface of the tool body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tool with colored patterns in accordance with the present invention;

FIG. 2 is an enlarged cross sectional top plan view of the tool in FIG. 1;

FIG. 3 is a cross-sectional top plan view of the tool in FIG. 1 with a colored pattern having a composite material; and

FIG. 4 is a side plan view of another embodiment of a tool with colored patterns in accordance with the present invention.

### DETAILED DESCRIPTION OF PREFERRED EMBODIMENT

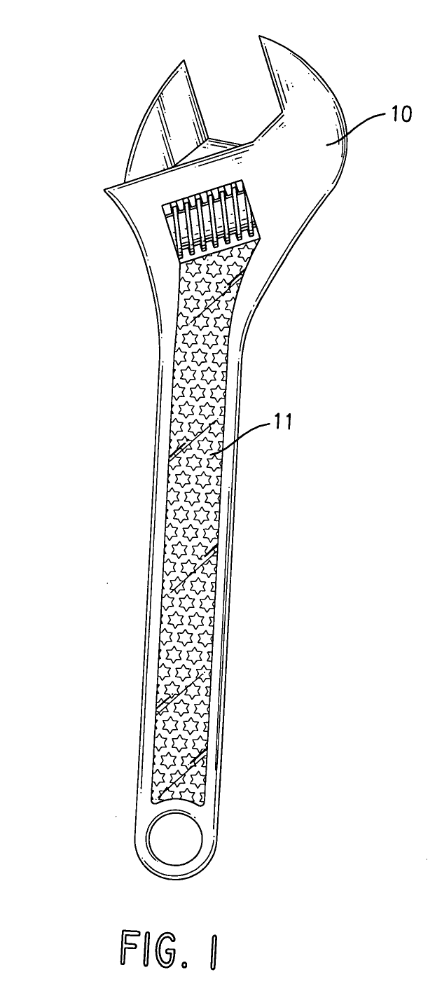

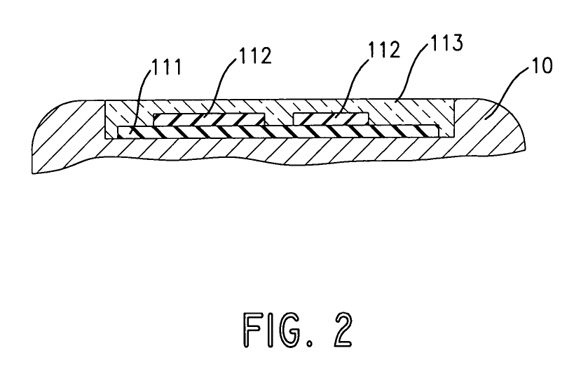

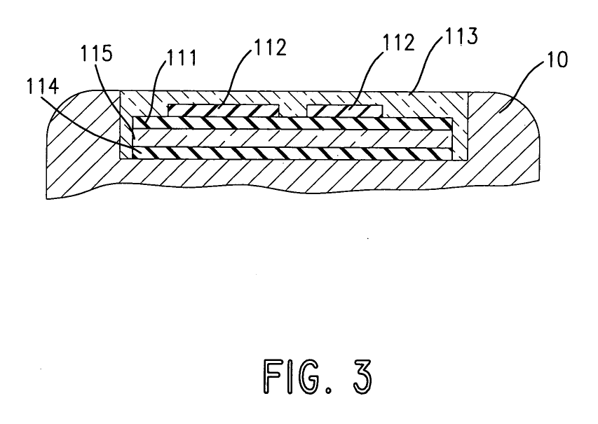

With reference to FIGS. 1, 2, and 3, a tool with colored patterns in accordance with the present invention comprises a tool body (10), at least one colored pattern layer (11), at least one optional composite layer (115) and an optional transparent film (113).

The tool body (10) is usually made of a metal and has a surface (not numbered). The at least one colored pattern layer (11) is applied to a part of the surface of the tool body (10), and has an adhesive layer (111) and a printed dye layer (112). The adhesive layer (111) is applied to part of the surface of the tool body (10), and may be glue to bond the at least one colored pattern layer (11) to the surface of the tool body (10). The printed dye layer (112) is applied to the adhesive layer (111) and may form colorful characters and figures. The at least one colored pattern layer (11) may have a releasable paper (not shown) to cover the adhesive layer (111). The at least one colored pattern layer (11) is pliable and readily conforms to any curved surface of the tool body (10) after the releasable paper is removed from the colored pattern layer.

The at least one optional composite layer (15) may be mounted between the at least one colored pattern layer (11) and the tool body (10) and is attached with an inner adhesive layer (114). The inner adhesive layer (114) is attached to the surface of the tool body (10) or a previously applied composite layer (115) and may be glue to attach the composite layer (15) to the surface of the tool body (10). The composite layer (115) is made of carbon fiber or glass fiber to improve the quality and appearance of the tool and is coated on the inner adhesive layer (114).

The optional transparent film (113) keeps the at least one colored pattern layer (11) from being damaged and is made from a hardening liquid composite material. The optional transparent film (113) can be applied by dipping the tool body (10) with the at least one colored pattern layer (11) into the liquid composite material or manually applying the liquid composite material to the at least one colored pattern layer (11).

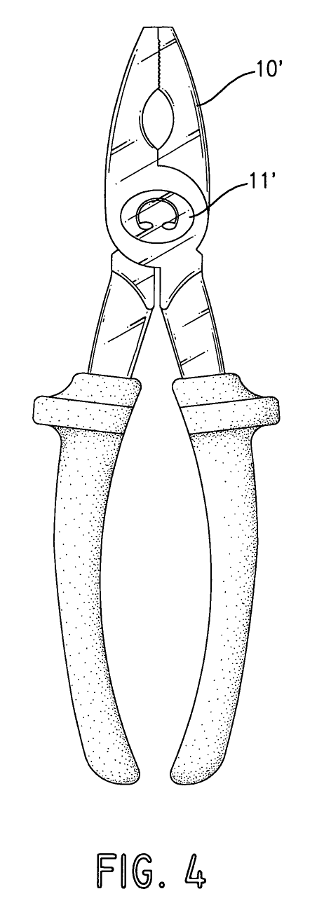

With reference to FIG. 4, another embodiment of a tool with colored patterns in accordance with the present invention has a tool body (10′) and a colored pattern layer (11′) mounted on a surface (not numbered) of the tool body (10′).

The present invention has the following improvements.

1. Applying the at least one colored pattern layer with exquisite and colorful characters or illustrations to any part of the surface of the tool body decorates the tool and makes the tool more attractive.

2. The color pattern layer readily conforms to any flat or curved surface of the tool body. Therefore the size and position of the characters and figures formed by the printed dye layer are more elastic so as the characters and figures of the colored pattern layer may be positioned at any preferred position on the tool body.

Even though numerous characteristics and advantages of the present invention have been set forth in the foregoing description together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A tool with colored patterns comprising:
a tool body having a surface; and
at least one colored pattern layer applied to the surface of the tool body and having:
an adhesive layer to be attached to the surface of the tool body; and
a printed dye layer applied to the adhesive layer.

2. The tool as claimed in claim 1, further comprising at least one composite layer and at least one inner adhesive layer mounted between the corresponding at least one colored pattern layer and the surface of tool body, wherein
the at least one inner adhesive layer attached to the surface of the tool body; and
the at least one composite layer attached to the at least one inner adhesive layer.

3. The tool with colored patterns as claimed in claim 1, further comprising a transparent film applied to the at least one colored pattern layer to keep the at least one colored pattern layer from being damaged.

4. The tool with colored patterns as claimed in claim 2, further comprising a transparent film applied to the at least one colored pattern layer to keep the at least one colored pattern layer from being damaged.
